(19) United States
(12) Patent Application Publication
(10) Pub. No.: US 2011/0121977 A1
(43) Pub. Date: May 26, 2011

(54) PNEUMATIC FIRE DETECTOR

(75) Inventors: Surendhar Reddy Nalla, Duarte, CA (US); John Navarro, Norco, CA (US); Ron Sayers, Arcadia, CA (US); Michael Warfel, La Verne, CA (US); William Philip Matchock, San Gabriel, CA (US)

(73) Assignee: PACIFIC SCIENTIFIC COMPANY, Duarte, CA (US)

(21) Appl. No.: 12/674,927

(22) PCT Filed: Sep. 5, 2008
(86) PCT No.: PCT/US2008/075321

§ 371 Date: Feb. 24, 2010

Related U.S. Application Data
(60) Provisional application No. 60/970,609, filed on Sep. 7, 2007.

(51) Int. Cl. G08B 17/04; B21D 26/021

(52) U.S. Cl. 340/584; 72/54

(57) ABSTRACT

A pneumatic fire detector is disclosed having a switch module comprising a manifold operatively connected to a sensor tube, the switch module incorporating respective forming tubes for applying a sufficient pressure to the outer surface of an installed diaphragm to deform it and thereafter the diaphragm is exposed to a pre-determined pressure through the manifold to deform the diaphragm outwards and into contact with a respective switch.

### CROSS REFERENCE TO RELATED APPLICATIONS

This application claims benefit as a continuation-in-part of U.S. Provisional Application No. 60/970,609, filed Sep. 7, 2007, the entire content of which is hereby incorporated by reference herein in its entirety for all purposes.

### FIELD OF THE INVENTION

The present disclosure relates to pneumatic fire detectors.

### BACKGROUND OF THE INVENTION

Reliable fire detection is critical for any aircraft used for cargo or passenger operations. There are several fire detectors available on the market which use diverse technologies to achieve detection. Some of the most common are point thermocouple, continuous thermocouple, resistance wire, and pneumatic tube.

A fire alarm system well known in the prior art incorporates a titanium or vanadium wire inserted into a capillary sensor tube. The wire is exposed to high temperature and pressurized hydrogen gas and absorbs the gas and stores it as the wire cools. This saturated wire is inserted into a sensor tube, pressurized with an inert gas, and sealed at both ends forming a pressure vessel, which can be used as a pneumatic detector.

The pressurized background gas expands in accordance to the physical gas laws. One of the ends is incorporated into a housing that comprises a plenum, where the alarm and integrity switches are located.

When the sensor tube portion of the pneumatic detector in its final form is exposed to high temperature, the pressure inside will rise. Pneumatic fire detectors in the prior art also utilize diaphragms that are pre-formed prior to assembly and have its edges typically brazed and which comprise part of the gas seal for the device. The purpose of pre-forming the diaphragm is to operatively position the diaphragm to form initially either: a) an open switch (alarm switch) condition requiring the background pressure to increase to create a closed or alarm condition, or, b) or a maintained closed switch (integrity switch) condition with the background pressure.

For an alarm switch configuration, the diaphragm is deformed: a) so that the diaphragm, responsive to a pre-determined background pressure, will further deform sufficiently outward and create a closed switch; and, b) that a portion of the interior side of the disc forms part of the pressure seal for the plenum.

With this configuration, in the event of an overheat or fire condition, pressure in the sensor tube and plenum would rise. If a pre-determined high temperature condition is reached, the pressure within the plenum will increase to such an extent that the diaphragm will be deformed outward and into electrical contact creating a closed switch.

Conversely, for an integrity switch configuration, the diaphragm is deformed: a) so that the diaphragm, responsive to a pre-determined drop in background pressure, will deform sufficiently inward and lose electrical contact creating an open switch; and, b) that a portion of the interior side of the diaphragm forms part of the pressure seal for the plenum.

With this configuration, the integrity switch would open if a loss of pressure occurs in the sensor tube or plenum. If a pre-determined pressure loss occurs, the pressure within the plenum will decrease to such an extent that the diaphragm will lose electrical contact creating an open switch.

Description of the background art is generally disclosed in U.S. Pat. No. 5,136,278 issued to Hay and U.S. Pat. No. 3,122,728 issued to Lindberg, Jr.

Besides its background, the '278 patent discloses a pneumatic pressure detector which features a pair of diaphragms juxtaposed to one another and forming between them a single gas tight plenum. This configuration was directed to space savings and weight reduction.

In order to assemble the pneumatic fire detector, it is first necessary for the customer to provide the specific temperatures for each alarm to become activated. The manufacturer then determines the pressure level that corresponds to the desired threshold temperature and can thereafter construct the necessary diaphragm shape, braze the edges to form the gas-tight seal and assemble the detector.

Well known in the prior art, these metallic diaphragms are stamped from metal sheets; typically flat discs which are thereafter manipulated or deformed prior to installation into the pressure detector assembly.

The degree of necessary deformation is dependent on the thickness and diameter of the diaphragm metallic disc as well as its material of construction. The diaphragm is thereafter pressure tested to insure electrical contact will be made with the switch upon a threshold pressure being reached inside the sensor tube. The fire detector is thereafter assembled with appropriate wiring, resistor(s) and electric connectors for communicating alarm and integrity signals.

### SUMMARY OF THE INVENTION

A pneumatic pressure detector is disclosed having a unique switch module design. The design allows the metallic discs or diaphragms that comprise a portion of the switch module to be deformed subsequent to assembly of the switch module. This pneumatic detector is suitable for aircraft as well as other demanding applications.

In this disclosure, the term “comprising” means including the elements or steps that are identified following that term, but any such elements or steps are not exhaustive, and an embodiment may include other elements or steps.

In this specification, the term “deformed” means the altering of the surface contour of a diaphragm.

The pneumatic fire detector includes a sensor tube that is operably connected to a switch module. The switch module comprises a manifold having a first opening, defined as the inlet, operably connected to the sensor tube. The manifold can be designed with at least two other openings, termed outlets, for operable connection to respective integrity and alarm switches. At least one integrity switch and at least one alarm switch comprise the switch module. Across each outlet is a substantially flat deformable metallic diaphragm disc permanently secured into position along its circumference either by brazing or welding to form a gas-tight seal between the manifold and each respective header assembly 32. Inside the switch module, facing a respective deformable diaphragm is an electrical contact pin.

The switch module can be designed in many configurations and to accommodate additional switches. For example, in order to accommodate a third switch, an additional outlet could be designed directly opposite the manifold inlet. As shown in FIG. 1, two switches are juxtaposed to one another for space economy with the third switch operably connected to the third outlet by a connecting tube. The distal end of the third outlet is connected to a switch housing 34 which is designed to maintain a gas-tight seal after the diaphragm has been welded into position. The connecting tube could also be in a T configuration to accommodate a fourth switch.

For purposes of this specification, the term manifold comprises that portion of the switch module which is exposed to the background pressure from the sensor tube when the unit is operational. For clarity, the manifold includes any additional outlets and respective connector tubes and switch housings 34.

The switch module is installed within the detector along with electrical circuitry to provide an alarm signal whenever the integrity switch opens or the alarm switch closes.

The key inventive step for the disclosed pneumatic fire detector is the ability to assemble the switch module, which incorporates at least one integrity switch and at least one alarm switch, prior to the diaphragms being deformed into an operative configuration. As used herein, the term operative configuration means either the alarm switch configuration of integrity switch configuration mentioned earlier.

The circumferential edges of each metallic disc are welded in place forming a gas-tight seal. In a preferred embodiment, electron beam welding per AMS 2681 is used for operably connecting the diaphragm to the switch module. The material for construction of the diaphragm is a TZM alloy.

The switch module or plenum incorporates a respective forming tube for the header assembly of each switch. Each forming tube has a first or proximal end opening into an enclosed gas-tight space located behind a respective metallic disc. In a preferred embodiment, the forming tube and contact pin are both in perpendicular relationship to the metallic disc. The forming tube extends through the switch module and can be temporarily connected on the distal end to a controllable pressure source.

The advantageous effect is the ability to secure the metallic discs in place, forming a gas-tight seal, and completely assemble the switch module without requiring the temperature settings for each alarm switch from the customer. Thus, the switch module can be produced in quantity.

Thus, the invention provides a means for deforming a diaphragm which has been secured into position along its circumference forming a gas-tight seal. The means for deforming comprises the application of a first pre-determined pressure applied through the forming tube sufficient to deform the diaphragm inward into a concave contour relative to the electrical contact pin and the subsequent application of a second pre-determined pressure through the manifold to check the responsiveness of the diaphragm.

The fire detector can be designed for any exterior shape but preferably is constructed having a generally cylindrical configuration.

The procedure for deforming a diaphragm is as follows:

a. The respective switch is electrically connected for testing whether the diaphragm will close the switch at a second pre-determined pressure.

b. A first pre-determined pressure is applied through the forming tube to the diaphragm. This forming tube pressure is sufficient to deform the diaphragm inward in a substantially concave contour relative to the electrical contact. The severity of the deformation is dependent upon the thickness, diameter and type of metallic disc used as well as the pressure being applied.

c. The pressure in the forming tube is bled-off.

d. Next, pressure is applied through the manifold inlet to the convex surface of the diaphragm. This manifold pressure is sufficient to deform the diaphragm outward and toward electrical contact. The manifold pressure is gradually increased to a second pre-determined pressure that corresponds to the threshold temperature for the alarm. If the alarm switch closes within an acceptable range about the desired pressure such as ±2 psig, and more preferably ±1 psig, the diaphragm is operatively configured. If the alarm switch closes at a pressure below the acceptable range, the diaphragm will not function correctly.

e. The manifold pressure is bled-off.

f. Steps a-e are repeated with incrementally more pressure if electrical contact in d was not made at the desired pressure.

It is necessary that the forming tube pressure be of a sufficiently low pressure so as not to excessively deform the diaphragm inward. If this were to occur, diaphragm contact with the switch would occur at a much lower manifold pressure making the diaphragm unacceptable for use. It is for this reason that an incremental forming tube pressure increase procedure be applied for determining the correct forming tube pressure to use upon a metallic diaphragm having a specific thickness, diameter and physical properties. In a preferred embodiment, each diaphragm is deformed separately rather than all being deformed at the same time.

Thereafter, once all diaphragms have been appropriately deformed to function properly at a respective desired background pressure, the forming tube is sealed and the sensor tube is operatively connected to the switch module and pressurized with an inert gas to the desired pressure and sealed. The diaphragms subjected to the deforming procedure mentioned above will, in response to the sensor tube pressure, respond to the background pressure; namely, the integrity switch diaphragm will respond to the pressure and close, and the alarm switch will remain open until a pre-determined overheat condition occurs for which the diaphragm will contact and make it respective switch close.

Thus, an alarm means is provided for indicating a first or overheat condition, the alarm means comprising a deformable diaphragm having an outer surface normally spaced from a first electrical contact located outside of the manifold, the deformable diaphragm responsive to greater pressure from within the manifold to move toward the first contact for indicating the first or overheat condition.

Additionally, an integrity means is provided for indicating a fault condition of a decrease in gas pressure in the sensor tube, the integrity means comprising a deformable diaphragm having an outer surface normally in contact with a second electrical contact located outside of the manifold, with the deformable diaphragm being responsive to less gas pressure to move away from the second contact for indicating said fault condition.

As mentioned earlier, the switch modules can be made and assembled without knowledge of the temperature alarm settings desired by a customer. As an order is received, the procedure defined by the above steps a-f are used and after the diaphragms have been properly deformed to achieve electrical contact at the desired sensor tube pressure, the switch module can be installed within the detector housing and electrically connected.

Additionally, the time to complete a fire detector following receipt of a customer's order and specifications is reduced since subsequent labor to deform the already installed flat diaphragms require only the deforming procedure mentioned earlier. This allows a final product to leave the manufacturing facility in less time; thus making the overall method of manufacture extremely efficient.

### DESCRIPTION OF THE DRAWINGS

FIG. 1 is a side view of one embodiment for a pneumatic fire detector.

FIG. 2 is an illustrative side view of a switch module.

FIG. 3a is an illustrative view of a diaphragm electron beam welded into place.

FIG. 3b is an illustrative view of pressure being applied thru a forming tube and displacing the diaphragm inward.

FIG. 3c is an illustrative view of pressure being applied thru the manifold and displacing the diaphragm outward and into contact with its respective switch.

### BEST MODE FOR CARRYING OUT THE INVENTION

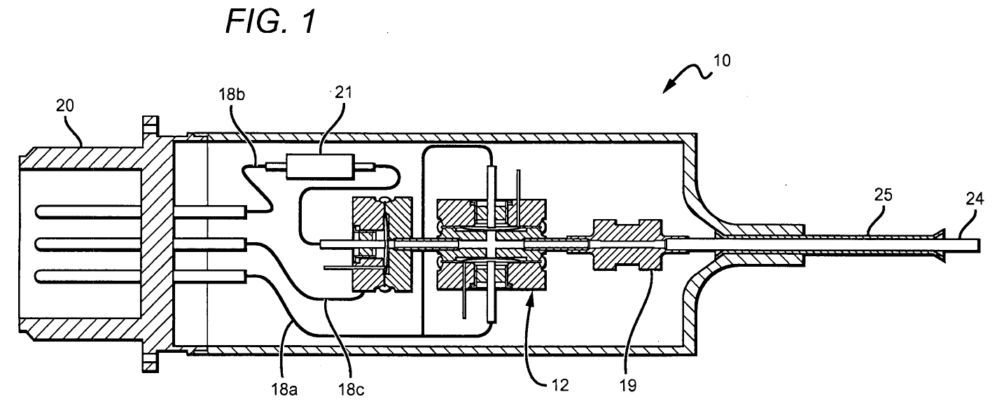

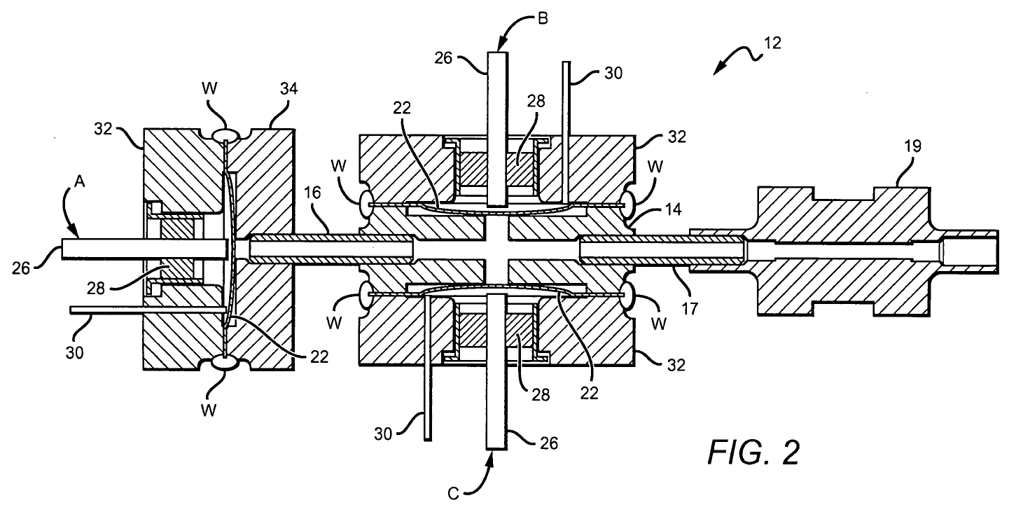

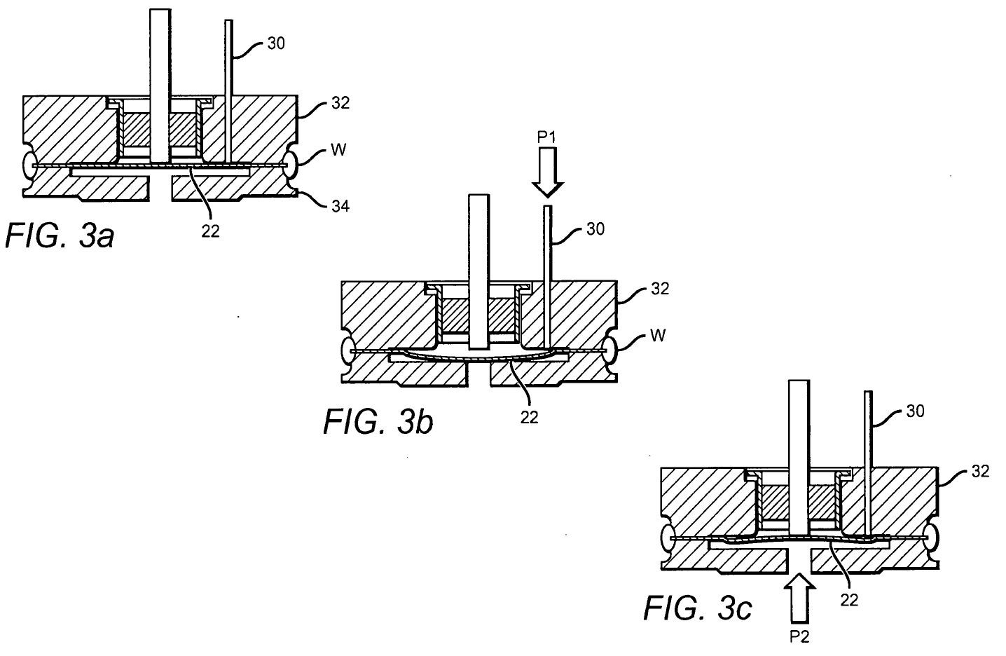

The pneumatic fire detector 10 is generally shown in FIG. 1 and incorporates a switch module 12 having a manifold 14. Switch module 12, shown in more detail in FIG. 2 and FIG. 3, illustrate a three switch embodiment, the switches depicted by A, B, and C. It is to be noted the illustrations are not drawn to scale and are presented for illustrative purposes.

The diaphragms 22 are made of flat metallic discs stamped out of TZM alloy sheet having an approximate thickness of 0.003″±0.0005″. The diameter of the discs are appropriately sized to form a gas-tight seal between either manifold 14 or switch housing 34 and the respective header assembly 32 when the metallic discs are correctly positioned and electron beam welded per AMS 2681 along its edge as represented by W.

Each respective header assembly 32 incorporates a forming tube 30. Each forming tube 30 has a first end opening into an enclosed gas-tight space located behind the outer surface of each diaphragm 22 and extends through respective header assembly 32. The distal end is configured to be temporarily connected to a controllable pressure source.

Switches A, B, and C each have an electrical contact pin 26 and a contact pin insulator 28. A configuration of connecting wires 18a, 18b, and 18c and resistor(s) 21, well known in the prior art, are used for transmitting a respective alarm or integrity signal via connector 20.

Manifold 14 is designed with four openings; one inlet for operably connecting to one end of the sensor tube 24 and three outlets for operative contact with a respective diaphragm 22.

The first switch, denoted in FIG. 1 as A, is a dedicated pressure integrity switch that is used to monitor the hermeticity of the pneumatic element that makes up the detector. Switch A is operably connected to manifold 14 by use of connecting tube 16. Connecting tube 16 is necessary because alarm switches B and C are juxtaposed to one another about manifold 14. For the same reason, a connecting tube 17 operably connects an isolator assembly 19 to manifold 14.

Isolator assembly 19 serves a dual function. Initially, it is used for connecting to a controlled pressure source and applying pressure through manifold 14 onto diaphragms 22 which is necessary for obtaining the desired operative configuration for each diaphragm. In a final assembled condition, isolator assembly 19 connects to sensor tube 24 with strain relief 25 used for support through housing 11.

What follows is the procedure by which diaphragms 22 are operably deformed after switch module 12 has been assembled and electrically connected for testing purposes.

As mentioned earlier, each diaphragm 22 has been electron welded into place as illustrated in FIG. 2, forming a respective gas-tight seal. A controllable pressure source (not shown) is temporarily connected to the distal end of forming tube 30. Referring to FIG. 3b, a first pre-determined pressure P1 is applied through forming tube 30 to diaphragm 22 creating a concave contour relative to header assembly 32.

By way of example, for a TZM alloy having a thickness of 0.003″ and an alarm requirement for signaling a 450° F. overheat condition, the switch must close at about 61 psig. In order to achieve this condition, the following steps are taken:
1. Approximately 1200 psig is applied through forming tube 30 to diaphragm 22 and maintained for at least one minute to permit maximum diaphragm deformation for this pressure. The pressure is thereafter bled-off.
2. Thereafter, approximately 61 psig is applied through manifold 14 from the controllable pressure source connected to isolator assembly 19. Pressure, represented by P2, is gradually increased from 0 psig to a second pre-determined pressure, in this case 61 psig. The pressure is thereafter bled-off.

At this point, three situations may be applicable.

First, if diaphragm 22 makes contact with contact pin 26 before the pressure reaches the desired pressure of 61 psig, steps 1 and 2 are repeated except that the forming tube pressure is incrementally increased by a pre-determined amount, such as between 5-50 psig. These steps are repeated until one of the other following conditions occur.

Second, if diaphragm 22 makes contact with contact pin 26 within a pre-determined range, in this case 61 psig±1 psig, the diaphragm is considered to be in its operative configuration. Thereafter, the respective forming tube 30 is sealed. Once all diaphragms 22 have been deformed to operative configuration, sensor tube 24 is connected to isolator assembly 19 and pressurized.

Third, if diaphragm 22 makes contact with contact pin 26 above 61 psig±1 psig is reached, the switch module cannot be used for those temperature conditions and is a result of excessive forming tube pressure being applied to the outer surface of diaphragm 22.

By this technique, each switch can be tailored to open at a specific operational pressure by varying the forming tube pressure used to create the shape of each diaphragm.

Once each diaphragm 22 has been pressured into its operable configuration, the functionality of the pressure detector is the same as available in the prior art.

The diaphragm associated with integrity Switch A moves into electrical contact with contact pin 26 when the calculated background pressure is introduced within sensor tube 24 and manifold 14 and remains closed for the life of the detector. However, the diaphragm is responsive to less gas pressure and designed to displace inward and break electrical contact in the event that the hermetic background pressure is lost from within the sensor tube 24.

The second and third switches, Switches B and C, are alarm switches that warn of a high temperature or fire condition.

Switch B is a normally open switch that remains open until an event occurs which causes the pressure to increase to a preset level within sensor tube 24 which in turn causes the diaphragm to deform outward and close an electrical circuit to Switch B.

Switch C also functions as an alarm switch in the same manner as Switch B and can either be a redundant switch if it is calibrated to make contact at the same pressure of Switch B or it can be set to make contact at a different temperature.

We claim:

1. A pneumatic pressure detector for use in an overheat or fire alarm system comprising:
a gas-tight manifold;
a sensor tube having one end operably connected to said manifold and pressurized with a gas;
at least one alarm means responsive to an increase in pressure of the gas in said sensor tube for indicating a first or overheat condition, said alarm means comprising a first deformable diaphragm having an outer surface normally spaced from a first electrical contact located outside of said manifold, said first deformable diaphragm responsive to greater pressure from within said manifold to move toward said first contact for indicating said first or overheat condition;
at least one integrity means for indicating a fault condition of a decrease in gas pressure in said sensor tube, said integrity means comprising a second deformable diaphragm having an outer surface normally in contact with a second electrical contact located outside of said manifold, said second deformable diaphragm being responsive to less gas pressure to move away from said second contact for indicating said fault condition; and,
said manifold, said first and said second deformable diaphragms and said first and said second electrical contacts comprising a switch module, said switch module further comprising a respective forming tube for each deformable diaphragm; said forming tube having a first end opening into an enclosed gas-tight space located behind said respective diaphragm for communicating a sufficient pressure to deform a respective diaphragm.

2. The pneumatic pressure detector of claim 1 wherein each of said deformable diaphragms is secured to said switch module by an electronic beam weld.

3. The pneumatic pressure detector of claim 1 wherein said deformable diaphragms are made of TZM alloy.

4. A method for deforming a diaphragm of a pneumatic pressure detector prior to operable connection of a sensor tube comprising the steps of:
a. providing a switch module comprising a manifold having an inlet for operatively communicating pressure; at least two switches each having a header assembly, each header assembly including: i) an electrical contact; ii) a forming tube, said forming tube having a proximal end and a distal end, said distal end for temporarily connecting to a controllable pressure source; iii) a substantially flat metallic diaphragm having an outer surface and disposed between said respective header assembly and said manifold, each of said diaphragms secured into position to form a gas-tight seal; where a space is defined as between the proximal end of said forming tube and said diaphragm;
b. operatively connecting a controllable pressure source to said manifold inlet;
c. operatively connecting a respective forming tube and;
d. applying a first pre-determined pressure through said respective forming tube to the diaphragm sufficient to deform said respective diaphragm into a substantially concave contour relative to said respective header assembly;
e. bleeding off the pressure in said respective forming tube;
f. incrementally increasing the pressure within said manifold until a second pre-determined pressure is reached;
g. bleeding off the pressure in said manifold;
h. repeating steps c-f if said diaphragm does not sufficiently deform and make contact with said respective electrical contact within 2 psig upon reaching said second pre-determined pressure, with said first pre-determined pressure incrementally increased by no more than 50 psig;
i. disconnecting said forming tube to the controllable pressure source; and,
j. disconnecting the operable connection of said manifold inlet.

5. The method of claim 4 where steps c-i are repeated for the respective diaphragm of each other header assembly of said switch module.

6. The method of claim 4 wherein said deformable diaphragms are made of TZM alloy.

7. The method of claim 4 wherein each of said diaphragms is secured into position using an electronic beam weld.

8. A pneumatic pressure detector for use in an overheat or fire alarm system having a switch module comprising a manifold which is operably connected to a sensor tube pressurized with a gas, the pressure detector including an alarm means where a portion of the alarm means is a first diaphragm having an outer surface normally spaced from a first electrical contact located outside of the manifold, the first diaphragm responsive to greater pressure from within the sensor tube to move toward the first electrical contact for indicating an overheat condition; and an integrity means where a portion of the integrity means is a second diaphragm normally in contact with a second electrical contact located outside of the manifold, the second diaphragm responsive to less gas pressure to move away from the second electrical contact for indicating a fault condition of a decrease in gas pressure in the sensor tube, the improvement comprising:
a respective forming tube for each diaphragm, said forming tube having a first end opening into an gas-tight space located behind the respective diaphragm, for delivery of pressure from a controllable pressure source to deform the respective diaphragm.

9. The pneumatic pressure detector of claim 8 wherein said deformable diaphragms are made of TZM alloy.

10. The pneumatic pressure detector of claim 8 wherein each of said diaphragms is operably connected to said switch module by an electronic beam weld.

11. A switch module as a component for a pneumatic pressure detector operatively connected to a sensor tube for use in an overheat or fire alarm system comprising:
a gas-tight manifold; said manifold having an inlet for operable connection to the sensor tube;
at least two header assemblies;
one header assembly configured to incorporate an alarm means responsive to an increase in pressure of the gas in the sensor tube for indicating a first or overheat condition, said alarm means comprising a first deformable diaphragm having an outer surface normally spaced from a first electrical contact located outside of said manifold, said first deformable diaphragm responsive to greater pressure from within said manifold to move toward said first contact for indicating said first or overheat condition;
a second header assembly configured to incorporate an integrity means for indicating a fault condition of a decrease in gas pressure in the sensor tube, said integrity means comprising a second deformable diaphragm having an outer surface normally in contact with a second electrical contact located outside of said manifold, said second deformable diaphragm being responsive to less gas pressure to move away from said second contact for indicating said fault condition; and,
each of said header assemblies further comprising a respective forming tube for each deformable diaphragm; said forming tube having a proximal end and a distal end, said proximal end opening into an enclosed gas-tight space located behind said respective deformable diaphragm, and said distal end configured for temporary connection to a controllable pressure source.

12. The pneumatic pressure detector of claim 11 wherein said deformable diaphragms are made of TZM alloy.

13. The pneumatic pressure detector of claim 11 wherein at least one of said deformable diaphragms is secured to said switch module and said manifold by an electronic beam weld.
